(19) United States
(12) Patent Application Publication
(10) Pub. No.: US 2007/0206660 A1
(43) Pub. Date: Sep. 6, 2007

(54) Radio frequency collision avoidance mechanism in wireless networks using frequency synchronization

(75) Inventor: Yariv Lifchuk, Tel Aviv (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/369,318

(22) Filed: Mar. 6, 2006

(51) Int. Cl. H04B 1/00

(52) U.S. Cl. 375/132

(57) ABSTRACT

A novel mechanism for avoiding RF collisions using frequency synchronization techniques. In one embodiment, a solution to the problem comprises dividing the channel map into different channel groups wherein each group includes a minimum number of channels. The composition of the channel groups depends on the number of piconets and the number of good and bad available channels. Thus, collisions are avoided by assigned each piconet a channel group where the channels in one group do not overlap the channels in other groups. As the channel map changes over time, the channel groups are dynamically updated with the new good and bad channels. In a second embodiment, all the neighboring piconets are configured to use the same channel sequence order. Each piconet, however, is assigned a different starting frequency (i.e. channel). Thus, collisions are avoided since at any instance in time, no two piconets are using the same channel.

### FIELD OF THE INVENTION

The present invention relates to the field of data communications and more particularly relates to a frequency synchronization based radio frequency (RF) collision avoidance mechanism for use in wireless networks.

### BACKGROUND OF THE INVENTION

Modern network communication systems are generally of either the wired or wireless type. Wireless networks enable communications between two or more nodes using any number of different techniques. Wireless networks rely on different technologies to transport information from one place to another. Several examples include, for example, networks based on radio frequency (RF), infrared, optical, etc. Wired networks may be constructed using any of several existing technologies, including metallic twisted pair, coaxial, optical fiber, etc.

Bluetooth is a short range wireless networking standard that is currently in popularity. It operates worldwide in the Industrial, Scientific and Medicine (ISM) frequency band at 2.45 GHz. The Bluetooth short range radio interface standard supports protocols and physical links for both packet switched asynchronous communications link (ACL) and circuit switched synchronous connection oriented communications (SCO). SCO links support symmetrical (equal bandwidth for uplink and down link), circuit-switched point-to-point connections typically used for voice. Applications based on SCO links may vary from replacement of the cordless telephone to wireless headsets to mobile phones, car hands free, interactive remote control and telemetry. ACL links can support symmetrical or asymmetrical (differing bandwidth between transmitter and receiver), packet switched, point to multipoint connections, typically used for bursty data transmission. Applications envisaged using the Bluetooth ACL link are wireless speakers, wireless Internet access, multimedia rendering, phone to Personal Digital Assistant (PDA) connectivity etc.

The number of devices that use Bluetooth is currently increasing at a rapid pace. Bluetooth devices communicate with each other in network groups known as piconets. A block diagram illustrating a prior art example ad hoc Bluetooth network is shown in FIG. 1A. The network, generally referenced 10, comprises a headset 12, mobile phone 14 and laptop or PC 16. The corresponding logical connectivity of this network is shown in FIG. 1B. The device are part of two different piconets wherein the headset 22 and mobile phone 24 are members of piconet #1 (pic1) and the laptop 26 and mobile phone 24 are members of piconets #2 (pic2). The mobile phone is the master 25 of pic1 and the headset is a slave. The laptop is the master of pic2 while the mobile is a slave 28 of pic2. The mobile is thus a member of both pic1 and pic2 as master and slave, respectively.

The growing number of Bluetooth devices in current use increases the probability that devices in different Bluetooth piconets will be within receiving range of each other and thus almost certain to interfere with each other. The Bluetooth specification supports the capability of a device to operate in up to three different piconets as a master in one piconets and a slave in the other two. The transmitted frequency of a piconet in each frame is determined by the master Bd_addres and the Bt_clock. Therefore, in a scatternet, the transmitted frequency for the different piconets within the same device may be identical. Due to the randomness of the Bluetooth frequency hopping scheme, the interference between Bluetooth devices is random and cannot be avoided by removing the channels using the Adaptive Frequency Hopping (AFH) channel map. This causes the retransmission of asynchronous communications link (ACL) packets which decreases the rate of transmission and causes delays in transmitting Link Manager Protocol (LMP) control packets. In links carrying voice data (i.e. voice links) this causes poor voice quality especially in high quality voice (HV) and Extended SCO (ESCO) packets that do not have retransmission.

Statistically, if there are three different piconets with AFH and all 79 channels are active, then a packet will be lost approximately every 147 msec. This is likely to cause diminished voice quality, lost of ACL packets, false detection of interferers (thus reducing the time to detect WLAN interference which is critical in mobile phones). The various statistical calculations of the time interval between lost packets are presented below.

In a scatternet with 3 piconets:

The probability of different piconets transmitting on the same channel is given by:
Px(n_{chan}=79)=(1/79+1/79)
Px(n_{chan}=60)=(1/60+1/60)
Px(n_{chan}=40)=(1/40+1/40)

The average time between use of the same frequency by different piconets at the same time is given by:
Tx(n_{chan}=79)=(1/Px)*1.25 msec=49 msec
Tx(n_{chan}=60)=(1/Px)*1.25 msec=30 msec
Tx(n_{chan}=40)=(1/Px)*1.25 msec=25 msec

The average time between lost packets in HV3 voice or EV3 is given by (a packet is sent every 3 frames):
Tlost(n_{chan}=79)=Tx*3=147 msec
Tlost(n_{chan}=60)=Tx*3=90 msec
Tlost(n_{chan}=40)=Tx*3=75 msec

In a scatternet with 2 piconets:

The probability of different piconets transmitting on the same channel is given by:
Px(n_{chan}=79)=(1/79)
Px(n_{chan}=60)=(1/60)
Px(n_{chan}=40)=(1/40)

The average time between use of the same frequency by different piconets at the same time is given by:
Tx(n_{chan}=79)=(1/Px)*1.25 msec=99 msec
Tx(n_{chan}=60)=(1/Px)*1.25 msec=75 msec
Tx(n_{chan}=40)=(1/Px)*1.25 msec=50 msec

The average time between lost packets in HV3 voice or EV3 is given by (a packet is sent every 3 frames):
Tlost(n_{chan}=79)=Tx*3=297 msec
Tlost(n_{chan}=60)=Tx*3=225 msec
Tlost(n_{chan}=40)=Tx*3=150 msec

The interference between Bluetooth devices of different piconets causes other problems including the false detection of interference that can reduce the rate of detection of non-Bluetooth interferers such as wireless LAN (WLAN) devices.

The problem of interference between devices of different networks that implement the same wireless standard exists not only in Bluetooth based networks but in other protocols as well, especially those that use frequency hopping, such as Ultra Wideband (UWB).

Thus, there is a need for a mechanism for avoiding RF collisions between Bluetooth devices that are members of different piconets but within reception range of each other.

### SUMMARY OF THE INVENTION

The present invention is a novel mechanism for avoiding RF collisions using frequency synchronization techniques. In one embodiment, a solution to the problem comprises dividing the channel map into different channel groups wherein each group includes a minimum number of channels. The composition of the channel groups depends on the number of piconets and the number of good and bad available channels. Thus, collisions are avoided by assigned each piconet a channel group where the channels in one group do not overlap the channels in other groups. As the channel map changes over time, the channel groups are dynamically updated with the new good and bad channels.

In a second embodiment, all the neighboring piconets are configured to use the same channel sequence order. Each piconet, however, is assigned a different starting frequency (i.e. channel). Thus, collisions are avoided since at any instance in time, no two piconets are using the same channel.

Advantages of the invention include (1) significantly reducing noise in voice connections; (2) avoiding mutual interferences between neighboring piconets; (3) an increased data rate due to decreased rate of retransmission; (4) avoiding detection of false interferers which disrupt the detection of real interferers such as WLANs; (5) reduced current consumption by avoiding triggering of quick learning algorithms (fast interferer detection system) with false interferer detection; and (6) relatively simple implementation.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is therefore provided in accordance with the invention, a method of avoiding radio frequency (RF) collisions in frequency hopping (FH) based wireless networks, the method comprising the steps of determining, from a plurality of available channels, a good channel map comprising a plurality of good channels and a bad channel map comprising a plurality of bad channels, dividing the good channel map and the bad channel map into a plurality of channel groups, each channel group associated with a different network and comprising a minimum number of channels; the step of dividing comprising the steps of first assigning the good channels substantially equally among networks carrying voice while minimizing any common shared good channels and second assigning any remaining good channels to non-voice networks.

There is also provided in accordance with the invention, an apparatus for avoiding radio frequency (RF) collisions in frequency hopping (FH) based wireless networks comprising means for determining, from a plurality of available channels, a good channel map comprising a plurality of good channels and a bad channel map comprising a plurality of bad channels, means for dividing the good channel map and the bad channel map into a plurality of channel groups, each channel group associated with a different network and comprising a minimum number of channels; the means for dividing comprising first means for assigning the good channels substantially equally among networks carrying voice while minimizing any common shared good channels and second means for assigning any remaining good channels to non-voice networks.

There is further provided in accordance with the invention, a communications transceiver adapted to communicate in a plurality of frequency hopping (FH) based wireless networks comprising a transmitter coupled to the networks, a receiver coupled to the networks, a frequency synchronization module for avoiding radio frequency (RF) collisions in the networks, the frequency synchronization module comprising means for determining, from a plurality of available channels, a good channel map comprising a plurality of good channels and a bad channel map comprising a plurality of bad channels, means for dividing the good channel map and the bad channel map into a plurality of channel groups, each channel group associated with a different network and comprising a minimum number of channels; the means for dividing comprising first means for assigning the good channels substantially equally among networks carrying voice while minimizing any common shared good channels and second means for assigning any remaining good channels to non-voice networks.

There is also provided in accordance with the invention, a method of avoiding RF collisions in a plurality of frequency hopping based wireless networks, the method comprising the steps of setting a channel sequence order common to all the networks, assigning a unique start frequency to each network and synchronizing all the networks to begin hopping at a particular time instance on their respective start frequencies.

There is also provided in accordance with the invention, an apparatus for avoiding RF collisions in a plurality of frequency hopping based wireless networks comprising means for setting a channel sequence order common to all the networks, means for assigning a unique start frequency to each network and means for synchronizing all the networks to begin hopping at a particular time instance on their respective start frequencies.

There is further provided in accordance with the invention, a communications transceiver adapted to communicate in a plurality of frequency hopping (FH) based wireless networks comprising a transmitter coupled to the networks, a receiver coupled to the networks, a frequency synchronization module for avoiding RF collisions in the networks comprising means for setting a channel sequence order common to all the networks, means for assigning a unique start frequency to each network and means for synchronizing all the networks to begin hopping at a particular time instance on their respective start frequencies.

### BRIEF DESCRIPTION OF THE DRAWINGS

The invention is herein described, by way of example only, with reference to the accompanying drawings, wherein:

FIG. 1A is a block diagram illustrating a prior art example ad hoc Bluetooth network;

FIG. 1B is a block diagram illustrating the corresponding logical connectivity of the network of FIG. 1A;

FIG. 2 is a block diagram illustrating an example ad hoc Bluetooth network including a device incorporating the mechanism of the present invention that is a master and slave in two piconets;

FIG. 3 is a block diagram illustrating the frequency synchronization channel mapping mechanism of the present invention;

FIG. 4 is a flow diagram illustrating the new channel method;

FIG. 5 is a flow diagram illustrating the frequency synchronization method for two piconets wherein one carries voice;

FIG. 6 is a flow diagram illustrating the frequency synchronization method for two piconets wherein two carry voice;

FIG. 7 is a flow diagram illustrating the frequency synchronization method for three piconets wherein one carries voice;

FIG. 8 is a flow diagram illustrating the frequency synchronization method for three piconets wherein two carry voice;

FIG. 9 is a flow diagram illustrating the frequency synchronization method for three piconets wherein three carry voice;

FIG. 10 is a block diagram illustrating an example channel sequence for a plurality of piconets; and

FIG. 11 is a flow diagram illustrating the frequency synchronization channel order method of the present invention.

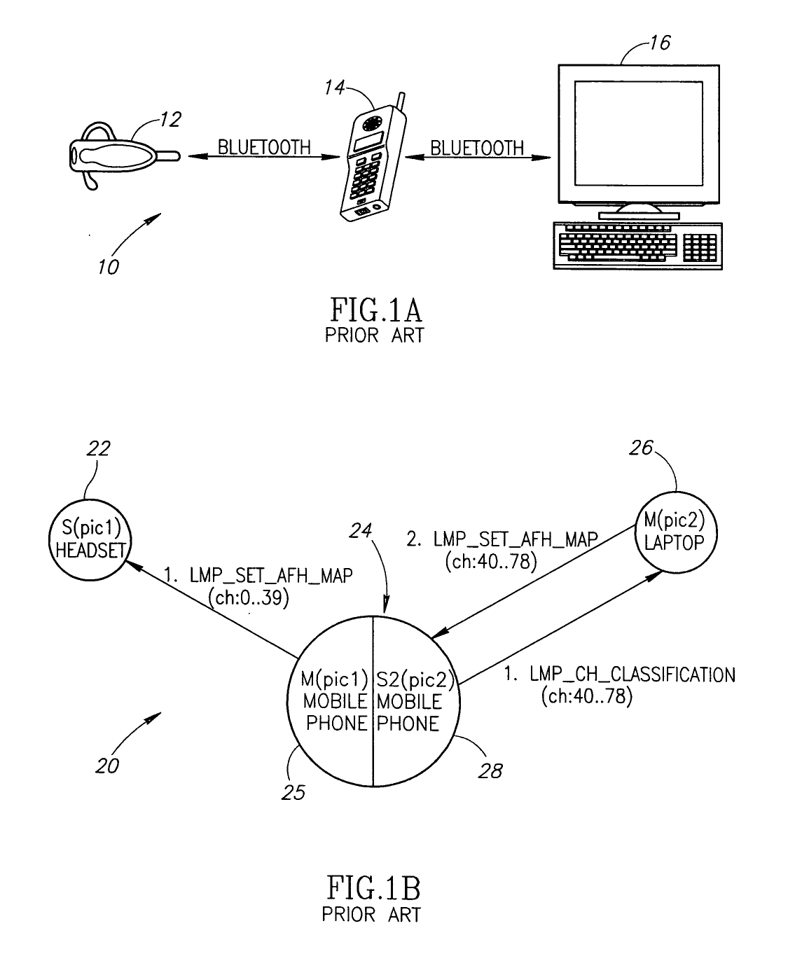

### DETAILED DESCRIPTION OF THE INVENTION

### Notation Used Throughout

The following notation is used throughout this document.

| Term | Definition |
|---|---|
| ACL | asynchronous communications link |
| AFH | adaptive frequency hopping |
| AHS | adapted hop sequence |
| ASIC | Application Specific Integrated Circuit |
| DSP | Digital Signal Processor |
| ESCO | Extended SCO |
| EV | Enhanced Voice |
| FH | Frequency Hopping |
| FPGA | Field Programmable Gate Array |
| GE | Gigabit Ethernet |
| HCI | Host Controller Interface |
| HDL | Hardware Description Language |
| HV | High quality Voice |
| ISM | Industrial, Scientific and Medicine |
| LMP | Link Manager Protocol |
| PC | Personal Computer |
| PDA | Personal Digital Assistant |
| PDU | Protocol Data Unit |
| RF | Radio Frequency |
| SCO | Synchronous Connection Oriented |
| UWB | Ultra Wideband |
| WLAN | Wireless Local Area Network |

### DETAILED DESCRIPTION OF THE INVENTION

The present invention is a novel mechanism for avoiding RF collisions using frequency synchronization techniques. To aid in understanding the principles of the present invention, the frequency synchronization based collision avoidance mechanism of the present invention is provided in the context of a Bluetooth network. Although the invention is described in the context of a Bluetooth capable network, it is appreciated that one skilled in the art can apply the principles of the invention to other communication networks, including frequency hopping based wireless networks, without departing from the scope of the invention.

Note that throughout this document, the term communications device is defined as any apparatus or mechanism adapted to transmit, receive or transmit and receive data through a medium. The term communications transceiver is defined as any apparatus or mechanism adapted to transmit and receive data through a medium. The communications device or communications transceiver may be adapted to communicate over any suitable medium, including wireless or wired media such as twisted pair cable or coaxial cable.

To aid in understanding the RF collision avoidance mechanism of the present invention, a brief overview of the Bluetooth adaptive frequency hopping mechanism is provided below.

### Adaptive Frequency Hopping and Classification

The adapted piconet physical channel uses at least Nₘᵢₙ RF channels, (where Nₘᵢₙ is equal to 20). The adapted piconet physical channel uses the adapted channel hopping. Adapted piconet physical channels are used for connected devices that have adaptive frequency hopping (AFH) enabled. There are two distinctions between basic and adapted piconet physical channels. The first is that the same channel mechanism that makes the slave frequency the same as the preceding master transmission. The second aspect is that the adapted piconet physical channel may be based on less than the full 79 frequencies of the basic piconet physical channel.

In total, six types of hopping sequences are defined: five for the basic hopping system and one for an adapted set of hop locations used by adaptive frequency hopping (AFH). These six sequences are listed below:

1. A page hopping sequence with 32 wake-up frequencies distributed equally over the 79 MHz, with a period length of 32;

2. A page response hopping sequence covering 32 response frequencies that are in a one-to-one correspondence to the current page hopping sequence. The master and slave devices use different rules to obtain the same sequence;

3. An inquiry hopping sequence with 32 wake-up frequencies distributed equally over the 79 MHz, with a period length of 32;

4. An inquiry response hopping sequence covering 32 response frequencies that are in a one-to-one correspondence to the current inquiry hopping sequence.

5. A basic channel hopping sequence which has a very long period length, which does not show repetitive patterns over a short time interval, and which distributes the hop frequencies equally over the 79 MHz during a short time interval.

6. An adapted channel hopping sequence derived from the basic channel hopping sequence which uses the same channel mechanism and may use fewer than 79 frequencies. The adapted channel hopping sequence is only used in place of the basic channel hopping sequence. All other hopping sequences are not affected by hop sequence adaptation.

### Adapted Hop Selection Kernel

The adapted hop selection kernel is based on the basic hop selection kernel defined in the Bluetooth specification. The inputs to the adapted hop selection kernel are the same as for the basic hop system kernel except that the input AFH_channel_map is used. The AFH_channel_map indicates which RF channels are used and which are unused. When hop sequence adaptation is enabled, the number of used RF channels may be reduced from 79 to some smaller value N. All devices should be capable of operating on an adapted hop sequence (AHS) with Nₘᵢₙ≦N≦79, with any combination of used RF channels within the AFH_channel_map that meets this constraint. Adaptation of the hopping sequence is achieved through two additions to the basic channel hopping sequence.

Unused RF channels are re-mapped uniformly onto used RF channels. That is, if the hop selection kernel of the basic system generates an unused RF channel, an alternative RF channel out of the set of used RF channels is selected pseudo-randomly. The used RF channel generated for the master-to-slave packet is also used for the immediately following slave-to-master packet.

### Hop Sequence Switching

Hop sequence adaptation is controlled by the master device and is set to either enabled or disabled. Once enabled, hop sequence adaptation applies to all logical transports on a physical link. Once enabled, the master periodically updates the set of used and unused channels as well as disable hop sequence adaptation on a physical link. When a master has multiple physical links the state of each link is independent of all other physical links.

When hop sequence adaptation is enabled, the sequence selection hop selection kernel input is set to adapted channel hopping sequence and the AFH_channel_map input is set to the appropriate set of used and unused channels.

Additionally, the same channel mechanism shall be used. When hop sequence adaptation is enabled with all channels used this is known as AHS(79).

When hop sequence adaptation is disabled, the sequence selection input of the hop selection kernel is set to basic channel hopping sequence (the AFH_channel_map input is unused in this case) and the same channel mechanism is not be used. The hop sequence adaptation state is be changed when the master sends the LMP_set_AFH PDU and a baseband acknowledgement is received. When the baseband acknowledgement is received prior to the hop sequence switch instant, AFH_Instant, the hop sequence proceeds.

When hop sequence adaptation is being enabled or disabled the recovery sequence is the AFH_channel_map specified in the LMP_set_AFH PDU.

### Channel Classification and Channel Map Selection

RF channels are classified as being unknown, bad or good. These classifications are determined individually by the master and slave devices based on local information (e.g., active or passive channel assessment methods or from the Host via Host Controller Interface (HCI). Information received from other devices via LMP (e.g., an AFH_channel_map from a master or a channel classification report from a slave) is not to be included in the channel classification of a device.

A master with AFH enabled physical links determines an AFH_channel_map based on any combination of the following information:
Channel classification from local measurements (e.g., active or passive channel assessment in the Controller), if supported and enabled. The Host enables or disables local measurements using the HCI Write_AFH_Channel_Classification_Mode command, defined in the HCI Functional Specification, if HCI is present.
Channel classification information from the Host using the HCI Set_AFH_channel_classification command, defined in the HCI Functional Specification, if HCI is present. Channels classified as bad in the most recent AFH_Host_Channel_Classification are marked as unused in the AFH_channel_map.
Channel classification reports received from slave device in LMP_channel_classification PDUs, defined in the LMP Specification.

The algorithm used by the master device to combine these information sources and generate the AFH_channel_map is not defined in the Bluetooth specification and is implementation specific. The minimum number of channels used is equal to 20. If a master device determines that all channels should be used it may keep AFH operation enabled using an AFH_channel_map of 79 used channels, i.e. AHS(79).

### Adaptive Frequency Hopping

Adaptive Frequency Hopping (AFH) is used to improve the performance of physical links in the presence of interference as well as to reduce the interference caused by physical links on other devices in the ISM band. AFH is only be used during the connection state.

The LMP_set_AFH PDU contains three parameters: AFH_Instant, AFH_Mode, and AFH_Channel_Map. The parameter, AFH_Instant, specifies the instant at which the hopset switch becomes effective. This is specified as a Bluetooth Clock value of the master's clock that is available to both devices. The AFH_instant is chosen by the master and is an even value at least 6*Tpoll or 96 slots (whichever is greater) in the future, where Tpoll is at least the longest poll interval for all AFH enabled physical links. The AFH_instant is within 12 hours of the current clock value. The parameter AFH_Mode, specifies whether AFH is enabled or disabled. The parameter AFH_Channel_Map, specifies the set of channels that are used if AFH is enabled. When the LMP_set_AFH PDU is received the AFH_instant is compared with the current Bluetooth clock value. If it is in the past then the AFH_instant has passed and the slave immediately configures the hop selection kernel with the new AFH_mode and AFH_channel_map specified in the LMP_set_AFH PDU.

### Channel Classification

A master requests channel classification information from a slave that is AFH_enabled. A slave that supports the AFH_classification_slave feature performs channel classification and reporting according to its AFH_reporting_mode. The master controls the AFH_reporting_mode using the LMP_channel_classification_req PDU. The slave reports its channel classification using the LMP_channel_classification PDU. The slave reports pairs of channels as good, bad or unknown.

### Channel Classification Reporting Enabling and Disabling

A master enables slave channel classification reporting by sending the LMP_channel_classification_req PDU with the AFH reporting mode parameter set to AFH_reporting_enabled.

When a slave has had classification reporting enabled by the master it sends the LMP_channel_classification PDU according to the information in the latest LMP_channel_classification_req PDU. The LMP_channel_classification PDU is not sent if there has been no change in the slave's channel classification.

A master disables slave channel classification reporting by sending the LMP_channel_classification_req PDU with the AFH_reporting mode parameter set to AFH_reporting_disabled.

### First Embodiment: Channel Assignment

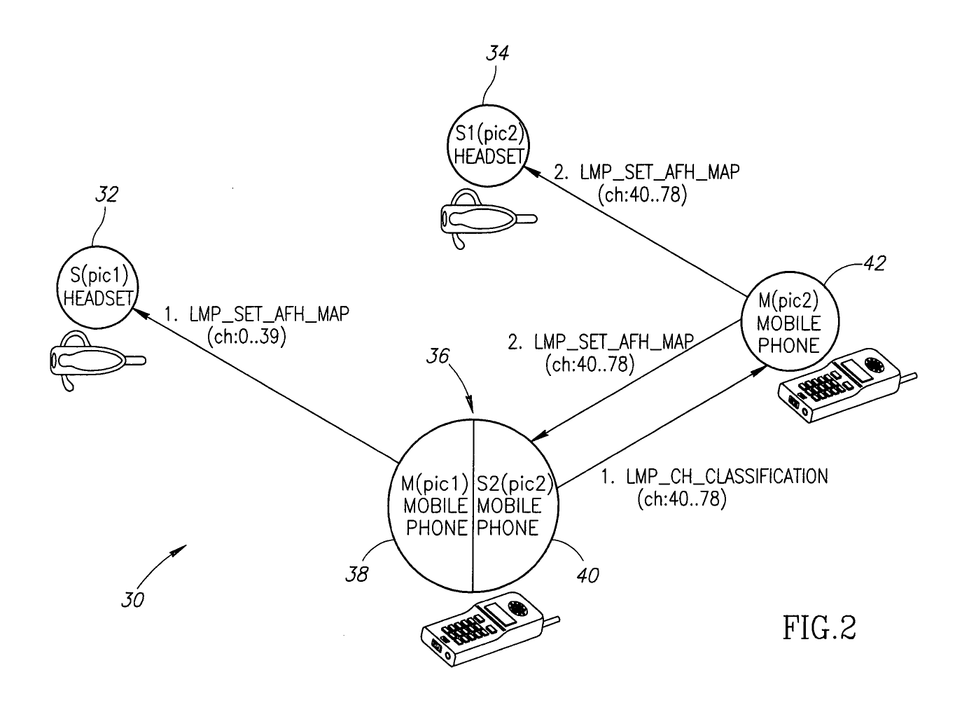

A block diagram illustrating an example ad hoc Bluetooth network including a device incorporating the mechanism of the present invention that is a master and slave in two piconets is shown in FIG. 2. The example network, generally referenced 30, comprises headsets 32, 34 and mobile phones 36, 42. Two piconets are shown wherein the first (pic1) comprises the slave headset 32 and master mobile 38. The second piconets comprises the master mobile 42, slave mobile 40 and slave headset 34. The mobile 36 is a member of both pic1 and pic2 as master and slave, respectively.

A Bluetooth capable device can handle up to three different piconets. The same device can perform a master role in one piconet and perform a slave role in two other piconets. If the piconets use Adaptive Frequency Hopping (AFH), however, collisions are likely to occur in transmitting packets as a result of the same frequency being used in two or three piconets at the same time. To avoid RF collisions, the present invention provides a mechanism wherein the channel map is divided into a plurality of groups of channels, each channel group associated with the different piconet.

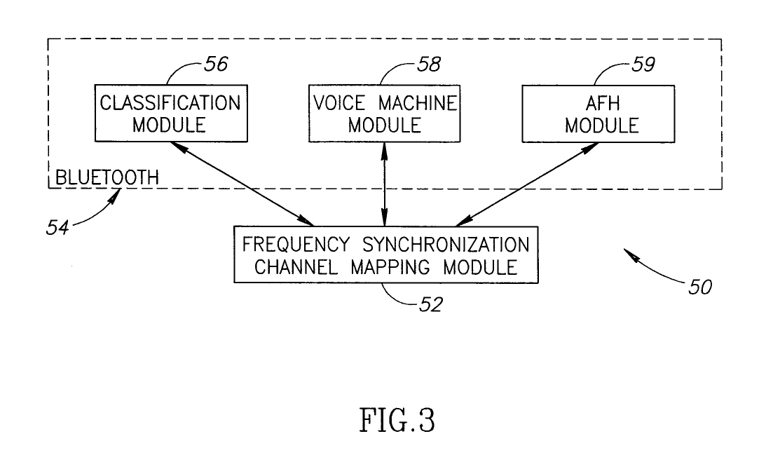

A block diagram illustrating the frequency synchronization channel mapping mechanism of the present invention is shown in FIG. 3. The system, generally referenced 50, comprises several Bluetooth components 54 and a frequency synchronization channel mapping module 52 which implements the RF collision avoidance mechanism of the present invention. The channel mapping module interface with the classification module 56, voice machine module 58 and AFH module 59.

The AFH feature in the Bluetooth standard supports choosing groups of frequencies to use. The invention defines a mechanism that divides the Bluetooth channel map among two or three different piconets in a specific manner described infra that avoids RF frequency collisions and thus avoid mutual interference in voice connections.

The mechanism may be activated at a suitable time such as after a voice connection is established. The mechanism is activated on a device only when the following conditions exist:
1. there are at least two piconets;
2. at least one of the piconets has a voice connection;

The device can determine the number of active piconets using any suitable technique. For example, the condition of more than one piconet is detected by examining specific hardware registers in the transceiver that indicate the active piconets. The voice connection is checked, for example, by reading a status register within the hardware voice machine. Once these two conditions are detected, the collision avoidance mechanism is activated.

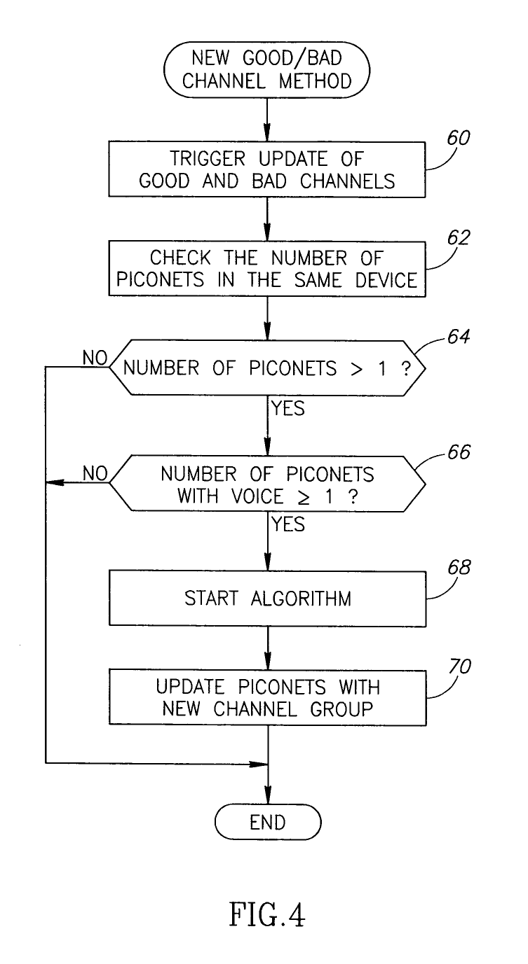

After the algorithm is activated it is triggered by any update of the good and bad channel map. A flow diagram illustrating the new channel method is shown in FIG. 4. When new good or bad channels are added to the channel map (step 60), the algorithm calculates the new channel map of each piconet. When there is a change in the piconets, the method again checks whether to turn off the algorithm if the conditions are not valid. The number of piconets within the device is then checked (step 62). The mechanism is not activated if the number of piconets is not greater than one (step 64). If there are two or more piconets, the method then checks whether at least one of the piconets carries voice traffic (step 66). If so, the RF collision avoidance mechanism of the invention is activated (step 68) and each piconets is updated with its corresponding new channel group (step 70).

The following scenarios activate the mechanism:

Two piconets exists, only one piconet with voice.

Two piconets exists, two piconets with voice.

Three piconets exists, only one piconet with voice.

Three piconets exists, two piconets with voice.

Three piconets exists, three piconets with voice.

Each of these scenarios will now be described in more detail.

Two piconets exist only one with voice:

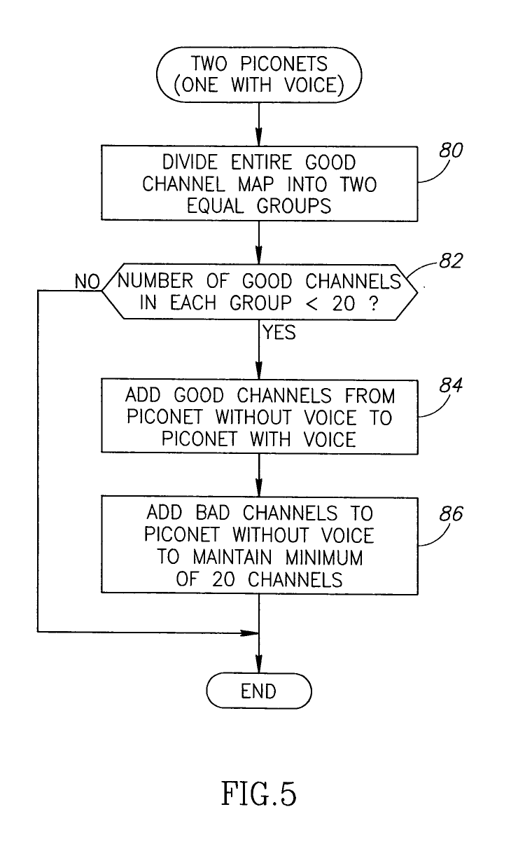

A flow diagram illustrating the frequency synchronization method for two piconets wherein one carries voice is shown in FIG. 5. The entire good channel map is divided into two equal groups (step 80). If there are less than 20 good channels in each group (step 82) then the piconet carrying voice traffic adds good channels from the piconet without the voice (step 84). Bad channels are added to the piconet without the voice traffic to complete a minimum of 20 channels (step 86).

In this case the voice piconet uses at least 20 good channels that are not used by the other piconet and the piconet carrying voice will not be interfered with by the other piconet. The piconet carrying data (i.e. non-voice) uses some bad channels that may cause lower throughput which is tolerable with a data connection as opposed to a voice connection. Note that every time a good channel is dropped or a bad channel is returned as a good channel, the mechanism is triggered and the good channel map groups are updated as described supra.

Two Piconets Exists, Two Piconets with Voice:

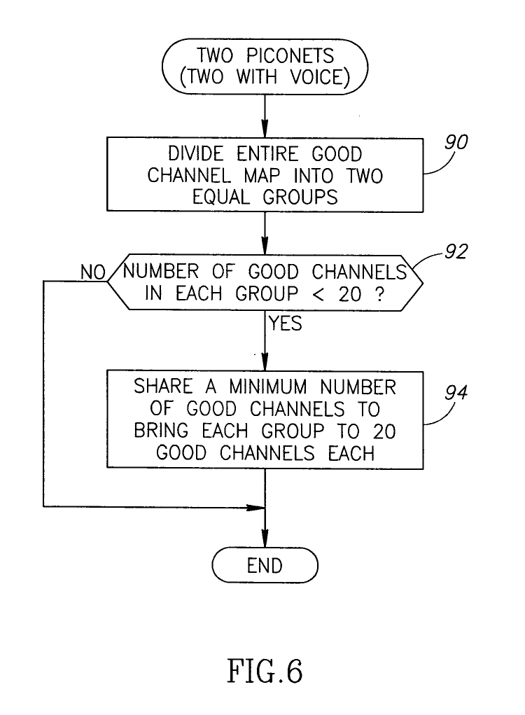

A flow diagram illustrating the frequency synchronization method for two piconets wherein two carry voice is shown in FIG. 6. Similar to the first scenario described above in connection with FIG. 5, the entire good channel map is divided into two equal groups (step 90). If there are less than 20 good channels in each group (step 92) then each piconet uses a minimum of common good channels to bring the number of good channels in each group to 20 (step 94). In this case, the voice traffic from each piconet may experience minimal interfere which cannot be avoided due to there being less than 40 good channels for both piconets.

Every time a good channel is dropped or a bad channel is returned as a good channel, the mechanism is triggered and the good channel map groups are updated as described supra.

Three Piconets Exists, Only one Piconet with Voice:

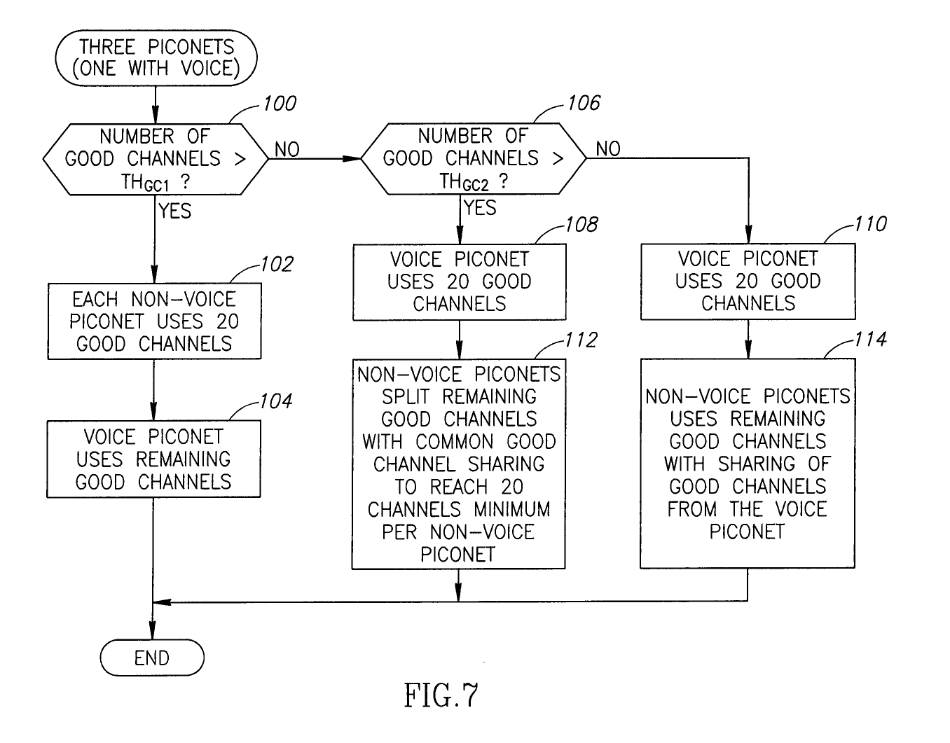

A flow diagram illustrating the frequency synchronization method for three piconets wherein one carries voice is shown in FIG. 7. The entire good channel map is divided in the following manner. If there are more than TH_{GC1} good channels (step 100) then each piconet not carrying voice traffic uses 20 separate good channels (step 102) and the piconet with voice traffic uses the remaining good channels (assuming there are more than 20) (step 104).

If there are less than TH_{GC1} good channels (step 100) but the number of good channels is greater than TH_{GC2} (step 106), then the piconet with voice traffic uses 20 good channels (step 108) and the two non-voice piconets split the remaining good channels wherein some common good channels are shared to complete 20 good channels (step 112). Note that TH_{GC1} is the threshold used to determine whether to use overlapping channels between two ACL connections. The range of TH_{GC1} is 20 to 79 with a preferred default value of 60. In addition, TH_{GC2} is the threshold used to determine whether to use overlapping channels between ACL and voice connections. The range of TH_{GC2} is 20 to 79 with a preferred default value of 30.

For example if there are 55 good channels (1-55) then the piconet carrying voice (pic1) uses channels 1-20, the first non-voice piconet (pic2) uses channels 21-41 while the second non-voice piconet (pic3) uses channels 36-55. Piconets pic2 and pic3 thus share common channels 36-41. In this case the piconet with voice (pic1) uses 20 good channels with no interfere from the other piconets resulting in high voice quality. The piconets carrying non-voice data (pic2, pic3) will have lower throughput because of the mutual interfere among the common good channels.

If there is less than 30 good channels (step 106), the piconet carrying voice uses 20 good channels (step 110) and the other two piconets use the remaining 10 good channels combined with either (1) a plurality of good channels from the voice piconet or (2) sharing bad channels to make 20 channels minimum per piconets (step 114).

Every time a good channel is dropped or a bad channel is returned as a good channel, the mechanism is triggered and the good channel map groups are updated as described supra.

Three Piconets Exists Two Piconets with Voice:

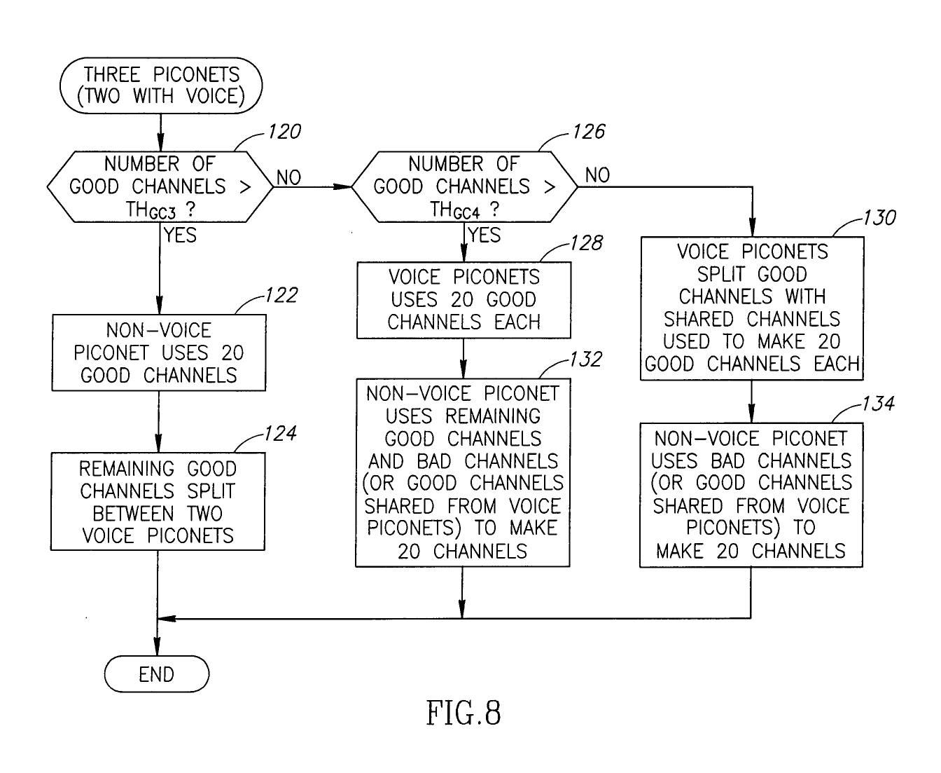

A flow diagram illustrating the frequency synchronization method for three piconets wherein two carry voice is shown in FIG. 8. The entire good channel map is divided in the following manner. If there are more than TH_{GC3} good channels (step 120) then each piconet not carrying voice traffic uses 20 separate good channels (step 122) and the remaining good channels are split between the two voice piconets (step 124).

If there are less than TH_{GC3} good channels (step 120) but the number of good channels is greater than TH_{GC4} (step 126), then the piconets with voice traffic use 20 good channels each (step 128) and the non-voice piconet uses the remaining good channels and bad channels (or good channels shared from the voice piconets) to make 20 channels (step 132).

If there is less than TH_{GC4} good channels (step 126), the piconets carrying voice split the good channels with shared channels used to make 20 channels each piconets (step 130). The non-voice piconets uses bad channels (or good channels shared from the voice piconets) to make 20 channels (step 134).

Note that TH_{GC3} is the threshold used to determine whether to use overlapping channels between ACL and voice connections or to use bad channels. The range of TH_{GC3} is 20 to 79 with a preferred default value of 60. In addition, TH_{GC4} is the threshold used to determine whether to use overlapping channels between two voice connections. The range of TH_{GC4} is 20 to 79 with a preferred default value of 40.

Every time a good channel is dropped or a bad channel is returned as a good channel, the mechanism is triggered and the good channel map groups are updated as described supra.

Three Piconets Exists Three Piconets with Voice.

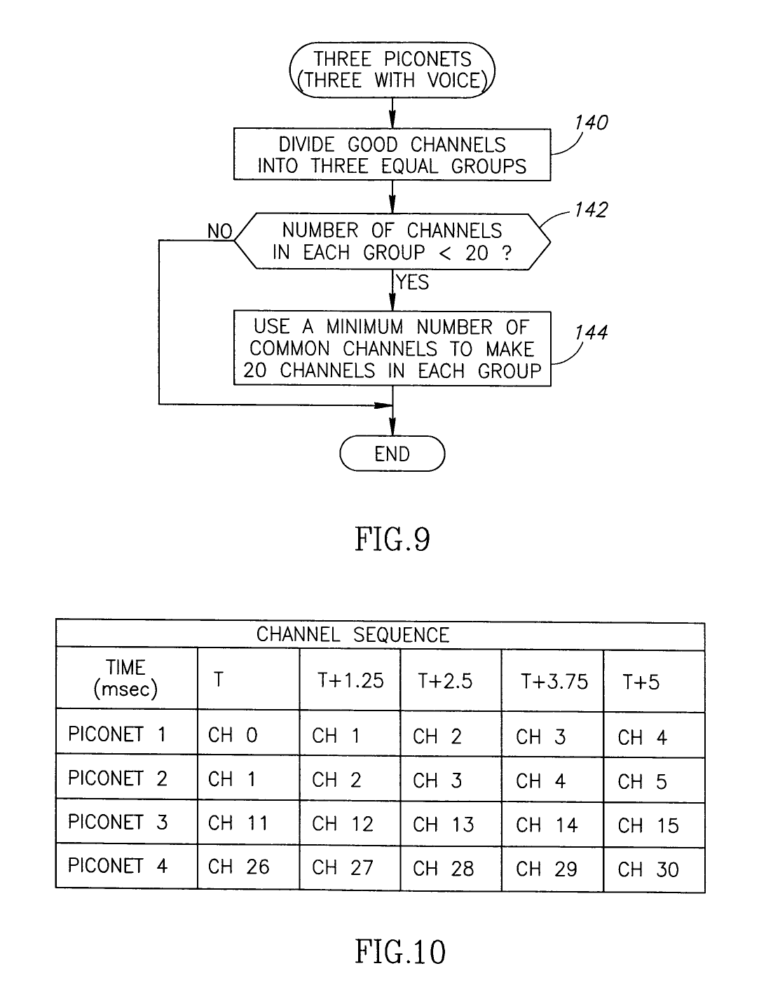

A flow diagram illustrating the frequency synchronization method for three piconets wherein three carry voice is shown in FIG. 9. The entire good channel map is divided in the following manner. The good channel map is divided into three equal groups (step 140). If there is less than 20 good channels in each group (step 142) then a minimum number of common channels are used to make 20 channels in each group (step 144).

Every time a good channel is dropped or a bad channel is returned as a good channel, the mechanism is triggered and the good channel map groups are updated as described supra.

After the device assigns the good channel map to the various piconets in use, it reports the channel groups using the standard protocol of AFH and Classification reports.

The good channel map is reported in the piconet in which the device is the master using the LMP_SET_AFH control packet with the detail good channel group. The packet is sent to all the slave devices in the piconet which set the new good channels as the working channels.

Good channels are reported in the piconet in which the device is a slave by using the LMP_CHANNEL_CLASSIFICATION control packet with the detail good channel group. The packet is sent to the master of the piconets. The master uses the report to send LMP_SET_AFH control packets that set the new good channels as the working channels.

Note that the implementation of the first embodiment channel assignment mechanism is transparent to devices that do not implement the mechanism of the present invention. The operation of the mechanism of the invention does not depend on other Bluetooth devices incorporating the invention.

### Second Embodiment: Channel Sequence Ordering

In a second embodiment of the invention, the RF collision problem is solved by using the same channel sequence order in all neighboring piconets while synchronizing each piconet to begin hopping on a different channel.

For example consider an example channel order: 0, 1, 2, 3, 4, 5, 6, . . . , 78, 0, 1, 2, . . . ). Each piconet is configured to use the same channel order. The starting frequency (or channel) of each piconets, however, is different as shown in FIG. 10. In this example, four piconets are listed wherein at time T piconet 1 uses channel 0, piconets 2 uses channel 1, piconets 3 uses channel 11 and piconets 4 uses channel 26. Although all the piconets use the same channel order, at any point in time each is transmitting on a different channel. In this manner, collisions are avoided and interference to voice traffic due to collisions with Bluetooth devices in neighboring piconets is prevented.

Currently, a device determines the channel transmitted as a function of two independent variables in the basic channel hopping sequence: (1) the Bd_address of the Master and (2) the Bt_clk of the master.

The Bd_Address of the master is a static variable in the connection and the relevant Bt_clk is increased by 1 every slot. Different piconets can use the same channel order by having the same Bd_addr. Two different piconets with the same channel order must use a different Bt_clk in order to use different channels. It is forbidden to have multiple piconets with the same Master device Bd_address. Therefore, the Bd_address in the channel order calculation is replaced by a generic address that both piconets use if this second embodiment of the invention is implemented after an LMP with special request is sent. The LMP also provides the Bt_clk that the other piconet Master uses in order to configure a different starting channel within the same channel hopping sequence.

In an adapted channel hopping sequence the channel to transmit is determined using the same function with an additional variable being the channel map permitted by the master device. When an unused RF channel is generated by the basic hop selection mechanism it is remapped to the set of used RF channels using a similar function that selects the next channel used by the Bd_address and Bt_clk of the master. When using the same Bd_address, the sequence maintains the same order even if some of the channels are unused in one of the piconets, thus avoiding channel collisions.

In an adapted channel hopping sequence the Bt_clk input of the channel calculation is increased by 1 every frame. The channel synchronization mechanism of the present invention can be used with piconets that use the basic channel hopping sequence or between piconets that use the adapted channel hopping sequence but cannot be used with mixed piconets (i.e. adapted and basic channels hopping sequence). Therefore the invention comprises a mechanism that initially modifies the hopping sequence of the other neighboring piconets to the channel hopping sequence of the initiating master device.

A more detailed description of the Bluetooth channel hopping sequence and associated calculations can be found in Part 2.6: Hop Selection in the Bluetooth system specification available on the Bluetooth web site: www.bluetooth.com.

Note that the first and second embodiments of the invention are applicable to systems other than Bluetooth. In particular, the invention can be implemented in protocols that use frequency hopping, such as ultra wideband (UWB).

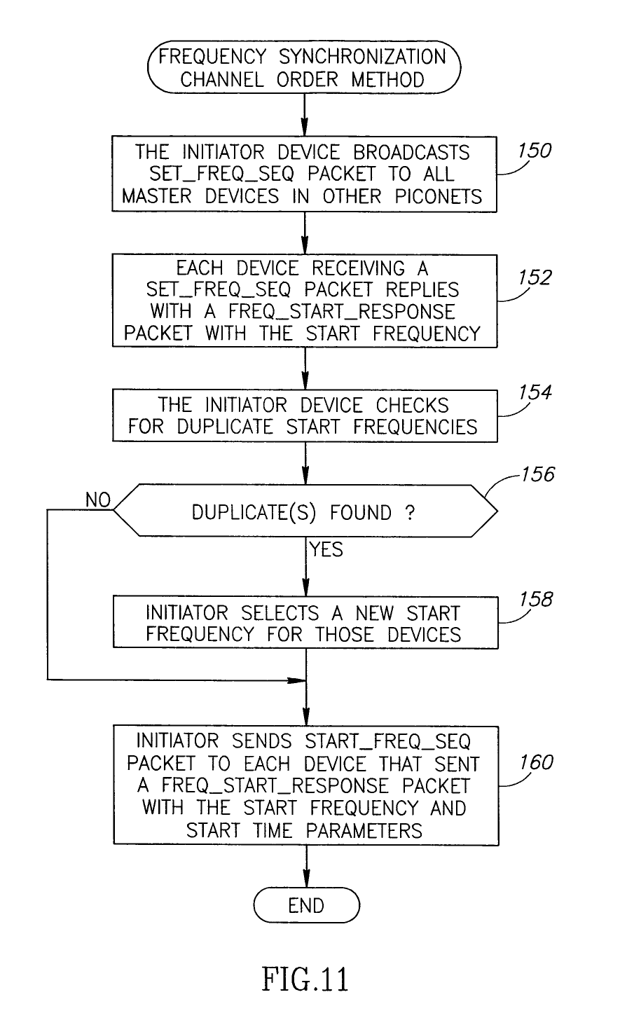

The channel sequence order method embodiment of the invention requires use of several packets as described below. A flow diagram illustrating the frequency synchronization channel order method of the present invention is shown in FIG. 11. The initiator device broadcasts a SET_FREQ_SEQ packet to all devices in the other neighboring piconets that are masters in their piconets (step 150). The SET_FREQ_SEQ packets comprise the correct channel sequence that each piconets is to use. Each device that receives the SET_FREQ_SEQ packet sends a FREQ_START_RESPONSE packet as a response. The FREQ_START_RESPONSE packet comprises the start frequency determined by that piconets (using its current clock) (step 152).

The initiator device receives all the response packets and checks whether there are any duplicate start frequencies (i.e. channels) (step 154). If there are duplicates found (step 156), it means at least two devices chose the same start frequency which much be corrected. In this case, the initiator selects a new start frequency for the those conflicting devices (step 158). A START_FREQ_SEQ packet is then sent by the initiator device to each of the devices that sent a FREQ_START_RESPONSE packet (step 160). The FREQ_START_RESPONSE packet includes several parameters including the starting frequency and the time instance at which the device should start using the new channel sequence order starting from its corresponding start frequency.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of avoiding radio frequency (RF) collisions in frequency hopping (FH) based wireless networks, said method comprising the steps of:
determining, from a plurality of available channels, a good channel map comprising a plurality of good channels and a bad channel map comprising a plurality of bad channels;
dividing said good channel map and said bad channel map into a plurality of channel groups, each channel group associated with a different network and comprising a minimum number of channels; said step of dividing comprising the steps of:
first assigning said good channels substantially equally among networks carrying voice while minimizing any common shared good channels; and
second assigning any remaining good channels to non-voice networks.

2. The method according to claim 1, further comprising allocating bad channels to non-voice networks in order to attain said minimum number of channels in each network.

3. The method according to claim 1, wherein said step of second assigning comprises the step of sharing a number of good channels among non-voice networks in order to attain said minimum number of channels in each network.

4. The method according to claim 1, further comprising the step of triggering the execution of said method upon establishment of a voice connection.

5. The method according to claim 1, further comprising the step of triggering the execution of said method upon when the number of networks is greater than one and at least one of said networks comprises a voice network.

6. The method according to claim 1, wherein said wireless networks comprise Bluetooth based wireless networks.

7. The method according to claim 1, further comprising the step of triggering the execution of said method upon the occurrence of an update to either said good channel map or said bad channel map.

8. The method according to claim 1, further comprising the step of determining whether to execute said method upon the occurrence of a change in said networks.

9. An apparatus for avoiding radio frequency (RF) collisions in frequency hopping (FH) based wireless networks, comprising:
means for determining, from a plurality of available channels, a good channel map comprising a plurality of good channels and a bad channel map comprising a plurality of bad channels;
means for dividing said good channel map and said bad channel map into a plurality of channel groups, each channel group associated with a different network and comprising a minimum number of channels; said means for dividing comprising:
first means for assigning said good channels substantially equally among networks carrying voice while minimizing any common shared good channels; and
second means for assigning any remaining good channels to non-voice networks.

10. A communications transceiver adapted to communicate in a plurality of frequency hopping (FH) based wireless networks, comprising:
a transmitter coupled to said networks;
a receiver coupled to said networks;
a frequency synchronization module for avoiding radio frequency (RF) collisions in said networks, said frequency synchronization module comprising:
means for determining, from a plurality of available channels, a good channel map comprising a plurality of good channels and a bad channel map comprising a plurality of bad channels;
means for dividing said good channel map and said bad channel map into a plurality of channel groups, each channel group associated with a different network and comprising a minimum number of channels; said means for dividing comprising:
first means for assigning said good channels substantially equally among networks carrying voice while minimizing any common shared good channels; and
second means for assigning any remaining good channels to non-voice networks.

11. A method of avoiding RF collisions in a plurality of frequency hopping based wireless networks, said method comprising the steps of:
setting a channel sequence order common to all said networks;
assigning a unique start frequency to each network; and
synchronizing all said networks to begin hopping at a particular time instance on their respective start frequencies.

12. The method according to claim 11, wherein said step of setting comprises sending a broadcast packet containing said channel sequence order.

13. The method according to claim 11, wherein said step of setting comprises the step of responding to a broadcast packet containing said channel sequence order with a packet containing a start frequency.

14. The method according to claim 11, wherein said step of assigning comprises the step of checking for duplicate start frequencies and if found assigning unique frequencies to each network.

15. The method according to claim 11, wherein said step of synchronizing comprises the step of sending packets to each responding device with a start frequency parameter.

16. The method according to claim 11, wherein said step of synchronizing comprises the step of sending packets to each responding device with a start time parameter.

17. The method according to claim 1, wherein said wireless networks comprise multiple Bluetooth piconets.

18. An apparatus for avoiding RF collisions in a plurality of frequency hopping based wireless networks, comprising:
means for setting a channel sequence order common to all said networks;
means for assigning a unique start frequency to each network; and
means for synchronizing all said networks to begin hopping at a particular time instance on their respective start frequencies.

19. A communications transceiver adapted to communicate in a plurality of frequency hopping (FH) based wireless networks, comprising:
a transmitter coupled to said networks;
a receiver coupled to said networks;
a frequency synchronization module for avoiding RF collisions in said networks, comprising:
means for setting a channel sequence order common to all said networks;
means for assigning a unique start frequency to each network; and
means for synchronizing all said networks to begin hopping at a particular time instance on their respective start frequencies.
